(19) United States
(12) Patent Application Publication
(10) Pub. No.: US 2006/0282215 A1
(43) Pub. Date: Dec. 14, 2006

(54) GLOBAL POSITIONING SYSTEM WITH REAL-TIME UPDATING

(76) Inventors: Ling-Yan Bao, Shanghai City (CN); Bo Yu, Shanghai City (CN); Shih-Kuang Tsai, Taipei Hsien (TW); Dai-Shui Ho, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/423,153

(22) Filed: Jun. 9, 2006

(30) Foreign Application Priority Data
Jun. 10, 2005 (TW) 094119417

(51) Int. Cl. G01C 21/00

(52) U.S. Cl. 701/213

(57) ABSTRACT

A Global Positioning System (GPS) updates an internal map database in real-time. The system has a module for collecting environmental data, a module for processing environmental data, and a module for conducting environmental data. The collecting module receives position data real-time and judges its usability. The processing module can transform the received data's format, so that the data format will be compatible with the system format. The module for conducting environmental data can insert received data and compare data to be inserted with existing system data to judge whether the GPS data should be updated. The goal of updating the system map database on the GPS in real-time is thus accomplished by the three modules.

### BACKGROUND OF THE INVENTION

1. Field of the Invention

The present invention relates to Global Positioning Systems (GPS), and more particularly to a GPS system that can be updated real-time with environmental data, and its related method.

2. Description of the Prior Art

Global Positioning Systems (GPS) were initially developed for military applications. However, with rapid improvements being made in the technology, GPS applications have expanded to such fields as civilian aviation, nautical navigation, vehicle/fleet control, oil bed exploration, meteorology, and earth sciences, to name a few. Some applications using GPS include transportation assistance, information gathering and management for environmental, ecological, foresting, and geological purposes, and surveying.

Please refer to FIG. 1, which is a module-level flow chart for a GPS device of the prior art. The GPS device comprises a receiving module 11, an environmental processing unit 12, and an electronic map data module 13. The receiving module 11 receives positioning data 111 from GPS satellites, and sends the positioning data 111 to the environmental processing unit 12, which converts the positioning data 111 to a numerical variable and converts a plurality of coordinates in the positioning data 111 to an electronic map coordinates format. The environmental processing unit 12 then sends a plurality of electronic map coordinates to the electronic map data module 13, allowing a driver to read an electronic map to discern a current location of the driver and determine an appropriate route to a desired destination.

If the current position of the driver is in a region of the electronic map, such as a remote alley or a newly constructed road, which is not sufficiently covered, or not covered at all, in map files of the GPS device, the device will fail to display information about the location and be unable to include the location when calculating the appropriate route. Further, after the GPS device has passed through the unknown region, the GPS device will not update the map files, such that the map files will continue to identify the unknown region as unknown.

### SUMMARY OF THE INVENTION

It is therefore an objective of the present invention to provide a GPS system with real-time updating. The GPS system comprises an environmental data collecting module, an environmental data processing module, and an environmental data conducting module. These three modules allow the GPS system to insert new environmental data in to a map database of the GPS system, thereby updating the GPS system data, removing originally unknown map regions, and expanding displayable map information in the system, leading to improved tracking and navigation abilities. Furthermore, the environmental data collecting module, the environmental data processing module, and the environmental data conducting module make the goal mentioned above of real-time updating in the GPS system realizable.

The environmental data collecting module comprises a receiving unit and an extracting unit. The receiving module comprises a receiving element and a packet data processing area. The receiving element and the packet data processing area receive data packet information through event firing or polling over a serial interface, thus effectively receiving environmental data from all sources. The extracting unit of the environmental data collecting module has an array symbol recognition function and an array contents read function, allowing the extracting unit to identify and extract needed information from very large data arrays, and convert cached bytes into usable position information.

The environmental data processing module comprises a data converting unit and a platform for data conversion. The data converting unit has a data processing function and a data conversion function, which can convert the received information into a numerical variable, and perform further processing based on practical use to generate a data message, which simplifies data processing. The data converting platform of the environmental data processing module has a projection conversion function and a coordinate conversion function. The data converting platform can convert the coordinates of the above data message into a Gaussian coordinates projection through a Gaussian projection conversion formula, and then transform the Gaussian coordinates of the projection to the coordinate system of the electronic map of the GPS system. In this way, the format of the received information and the format of the original system information are unified.

The environmental data conducting module comprises an environmental data comparing function, an environmental data updating function, an electronic map data module, and a display. The environmental data conducting module can compare the received information with the electronic map information. If the electronic map information is insufficient, the environmental data conducting module can update the system information, and display the result on the display, achieving the goals of increasing the system information and improving the tracking and navigation functions of the system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a data flow diagram of a Global Position System (GPS) system according to the prior art.

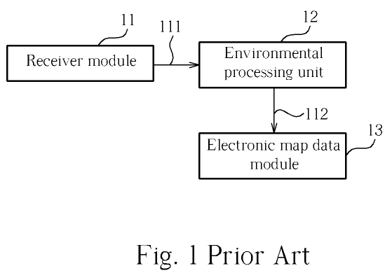

FIG. 2 is a data flow diagram of a GPS system with real-time updating according to the present invention.

FIG. 3 is a data flow diagram of an environmental data collecting module of the GPS system with real-time updating according to the present invention.

FIG. 4 is a data flow diagram of an environmental data processing module of the GPS system with real-time updating according to the present invention.

FIG. 5 is a data flow diagram of an environmental data conducting module of the GPS system with real-time updating according to the present invention.

### DETAILED DESCRIPTION

A preferred embodiment of a Global Positioning System (GPS) system with real-time updating, and its related method, of the present invention are described below. Where elements of the preferred embodiment match corresponding elements in the prior art, the same reference numbers are kept for the purposes of explanation.

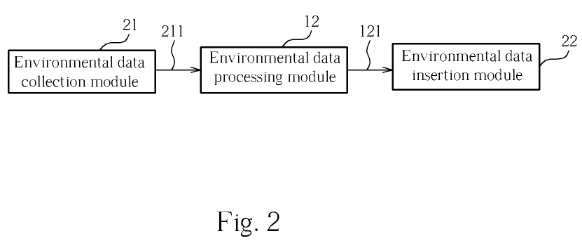

Please refer to FIG. 2, which is a data flow diagram of the GPS system with real-time updating of the present invention. The GPS system comprises an environmental data collecting module 21, an environmental data processing module 12, and an environmental data conducting module 22. After the environmental data processing module 12 receives real-time position information 211 from the environmental data collecting module 21, the environmental data processing module 12 sends formatted information 121 to the environmental data conducting module 22. The real-time position information 211 is a packet selected from a large array that has been determined to be useful. Parameters of the packet are already configured, and the formatted information 121 is a packet that is formatted to match the format of the system information.

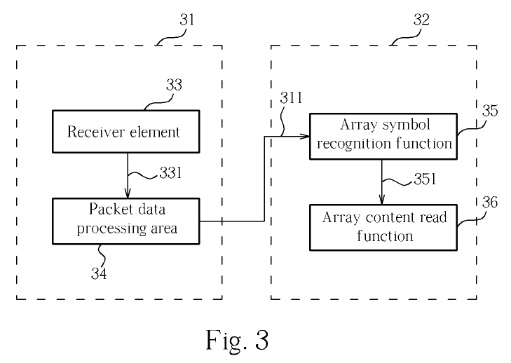

Please refer to FIG. 3, which is a data flow diagram for the environmental data collecting module 21 of the GPS system of the present invention. The environmental data collecting module 21 comprises a receiver module 31 and an extracting module 32. The receiving module 31 transmits cache information 311 to the extracting module 32. The receivinger module 31 further comprises a receiving element 33 and a packet data processing area 34. Based on a time interval setting, the receiving element 33 accepts position data, and sends the position data packet 331 to the packet data processing area 34 by means of an event trigger over a serial interface, or by polling the serial interface. The packet data processing area 34 decodes the data packet 331 and configures the parameters before sending the cache information 331 to the extracting module 32. The extracting module 32 comprises an array symbol recognition function 35 and an array content reading function 36. The array symbol recognition function 35 can recognize symbols in a data array to extract needed information, such as latitude and longitude, speed, and time, and the array symbol recognition function 35 also transmits an identification message 351 to the array content reading function 36. The reading function 36 can convert the identification message 351 from raw bytes to usable position information, which is the real-time position information 211 in FIG. 2.

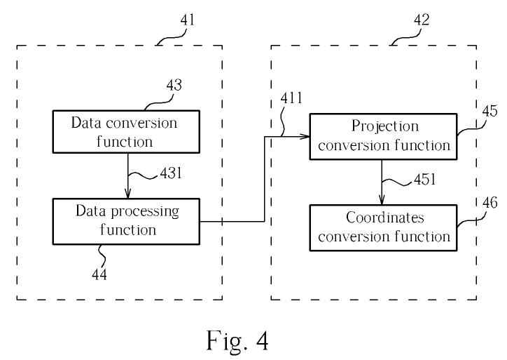

Please refer to FIG. 4, which is a data flow diagram for the environmental data processing module 12 of the GPS system with real-time updating of the present invention. The environmental data processing module 12 comprises a data conversion unit 41 and a coordinates conversion calculation area 42. The data converting unit 41 transmits a data message 411 to the coordinate conversion calculation area 42. The data converting unit 41 comprises a data converting function 43 and a data processing function 44. The data converting function 43 converts the real-time position information 211 from a character variable to a numerical variable, then sends a variable 431 to the data processing function 44. After the data processing function 44 has processed the variable 431 according to practical application demands, the data processing function 44 transmits the data message 411 to the coordinate conversion calculation area 42. The coordinate converting calculation area 42 comprises a projection converting function 45 and a coordinate converting function 46. The projection converting function 45 uses a coordinate converting formula to convert the longitude and latitude information of the data message 411 to Gaussian coordinates. In this way, the data message 411 becomes a projection message 451, which is sent to the coordinate converting function 46. The coordinate converting function 46 maps the Gaussian coordinate of the projection message 452 to coordinates of the GPS system internal electronic map. After mapping, the projection message 452 becomes the formatted information 121 of FIG. 2 above. In this way, the received information format matches the format of the original GPS system.

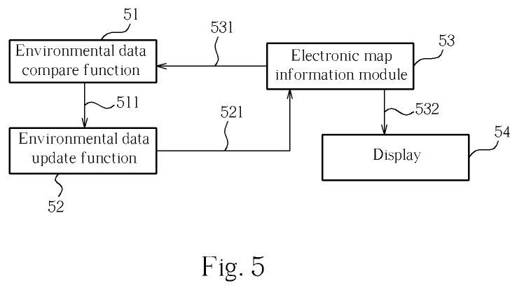

Please refer to FIG. 5, which is a data flow diagram for the environmental data conducting module 22 of the GPS system with real-time updating of the present invention. The environmental data conducting module 22 comprises an environmental data comparing function 51, an environmental data updating function 52, an electronic map information module 53, and a display 54. The environmental data comparing function 51 generates a comparing message 511 by comparing the formatted information 121 and map information 531 of the electronic map information module 53, and transmits the comparing message 511 to the environmental data updating function 52. The environmental data updating function 52 decides whether or not to update the map information of the system, and sends an updating message 521 back to the electronic map information module 53. The electronic map information module 53 then sends a display message 532 to the display 54, allowing a user to view the message. In this way, the system map information is increased, and navigation and tracking are improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system of Global Positioning System (GPS), comprising:
an environmental data collecting module for collecting real-time position data;
an environmental data processing module receiving and transforming the real-time position data from the environmental data collecting module into a message in a format compatible with the format of system data of the system; and
an environmental data conducting module receiving the message from the environmental data processing module for updating and optionally displaying geographical data stored in the environmental data conducting module according to the message.

2. The system of claim 1, wherein the environmental data collecting module comprises a receiving unit.

3. The system of claim 2, wherein the real-time position data is a data packet, and the receiving unit comprises:
a receiving element for periodically receiving the data packet; and
a packet data processing area connected to the receiving element for decoding the data packet.

4. The system of claim 3, wherein the packet data processing area performs data processing through polling of a serial interface.

5. The system of claim 3, wherein the packet data processing area performs data processing through event triggering.

6. The system of claim 1, wherein the environmental data collecting module comprises an extracting unit.

7. The system of claim 6, wherein the extracting unit functions to recognize array symbols.

8. The system of claim 7, wherein the extracting unit functions to read array content.

9. The system of claim 1, wherein the environmental data processing module comprises a data converting unit.

10. The system of claim 9, wherein the data converting unit functions to convert data.

11. The system of claim 9, wherein the data converting unit functions to process data.

12. The system of claim 1, wherein the environmental data processing module comprises a coordinates-transforming area.

13. The system of claim 12, wherein the coordinates-transforming area functions as projection transformation.

14. The system of claim 13, wherein the coordinates-transforming area functions as transformation of coordinates.

15. The system of claim 1, wherein the environmental data conducting module functions as comparison of environmental data.

16. The system of claim 1, wherein the environmental data conducting module functions as updating environmental data.

17. The system of claim 1, wherein the environmental data conducting module comprises a geographical information unit.

18. The system of claim 1, wherein the environmental data conducting module comprises a display unit.

19. A method for updating electronic geographical data in a system of GPS, the system comprising an environmental data collecting module, an environmental data processing module, and an environmental data conducting module, the method comprising steps of:
(a) collecting real-time position data at the environmental data collecting module;
(b) transmitting the real-time position data to the environmental data processing module;
(c) transforming the real-time position data into a message in a format compatible with the format of system data of the system at the environmental data processing module;
(d) transmitting the message to the environmental data conducting module; and
(e) updating and optionally displaying the geographical data according to the message at the environmental data conducting module
